(19) United States
(12) Patent Application Publication
(10) Pub. No.: US 2019/0099945 A1
(43) Pub. Date: Apr. 4, 2019

(54) COMPOSITE MATERIALS FOR THREE DIMENSIONAL (3D) PRINTING OBJECTS FOR CONSTRUCTION APPLICATIONS

(71) Applicant: DISNEY ENTERPRISES, INC., BURBANK, CA (US)

(72) Inventors: ALEXANDER W. HSING, GLENDALE, CA (US); AMAN LORENZO THOMAS, BETHESDA, MD (US)

(21) Appl. No.: 15/720,065

(22) Filed: Sep. 29, 2017

(51) Int. Cl. B29C 64/165; B29C 64/194

(52) U.S. Cl. CPC B29C 64/165; B29C 64/194; C04B 24/2623; C08K 2201/016; C08K 2201/003; C08L 2205/18

(57) ABSTRACT

A 3D printer material that includes one or more additives or additive materials mixed with a base material (e.g., a powder for use in binder jetting or a paste for use in extrusion). The additives may be fine powders (or spherical additives), fibers, aggregates, or a combination thereof with the particular additive material(s) and the ratio of additive to base being carefully chosen to achieve desired physical and/or chemical characteristics in the 3D object printed using the new 3D printer material. The addition of powders and/or fibers serves to strengthen the 3D printed material produced through binder jetting or extrusion. In particular, the new 3D printer materials address the issue of weak interfaces between printed horizontal layers since the additives either improve packing or bridge the layers of the 3D printed object.

### BACKGROUND

### 1. Field of the Description

The present invention relates, in general, to fabrication of three dimensional (3D) objects, and, more particularly, to printing materials specially configured to print structural and/or larger 3D objects that may have appropriate strength and/or other characteristics for use in construction applications.

### 2. Relevant Background

3D printing is an additive technology in which objects (or “printed 3D objects”) are created from a digital file. The digital file may be generated from software such as a computer aided design (CAD) program or another 3D modeling program or with a 3D scanner to copy an existing object that provides input to a 3D modeling program. To prepare the digital file for printing, software, provided on a printer-interfacing computer or running on the 3D printer itself, slices the 3D model into hundreds to thousands of horizontal layers. When the prepared digital file of the 3D object is uploaded into the 3D printer, the 3D printer creates the object layer-by-layer. The 3D printer reads every slice (or 2D image) from the 3D model and proceeds to create the 3D object by laying down (or printing) successive layers of material until the entire object is created. Each of these layers can be seen as a thinly sliced horizontal cross section of the eventually completed or printed 3D object.

The uses for 3D printing technologies has rapidly expanded in recent years, but it has typically been limited to use in prototyping objects and forming objects that are relatively small. Often, these objects are formed by only printing the outer shell or outer walls to save time and reduce material requirements. When larger objects are desired, 3D printing is often performed using extrusion or binder jetting. In extrusion-based 3D printing, the print material is extruded from a print nozzle using a reservoir and a pump, and the print material may generally be a paste that may be a wet cement, sand and epoxy, or the like. Each additional or added layer is applied once the previous layer has set or cured (which is why 3D printing is also referred to as additive manufacturing).

Other 3D printers use binder jetting (or powder bed 3D printing) to form the horizontal layers. The print head moves across a bed of powder (or printer material) that may be a sand, ceramic, a cement, or other material, selectively depositing a liquid binding material (or “binder”) such as a glue (e.g., to cure, react with, or activate the printer material or powder as appropriate (e.g., water may be used to activate a starch and gypsum plaster powder). In other binder jetting-based 3D printers laser sintering is used to form each layer in the printer material or powder. A thin layer of powder is spread across the completed section, and the process is repeated with each layer adhering to the prior layer. A moving platform may progressively lower the bed supporting the powder or printer material after each layer is formed and the solidified object rests in and is supported by the unbinded powder or printer material. New powder is added to the bed from a powder reservoir to allow each new layer to be formed by the printer head such as via a leveling mechanism moving the powder from the powder reservoir (or from the printer material supply). When the model is complete, the unbound powder or printer material is removed in a process called de-powdering.

While 3D printing can be performed via binder jetting or extrusion to form relatively larger 3D objects, the printed material tends to be mechanically weak such that is not suitable for high strength or stress applications including for use in construction. For example, a 3D printed wall typically would not be structurally sound or a 3D printed bench would not support a person's weight if formed using conventional binder jetting and extrusion technologies. In particular, the binder jetting printer method produces weak interfaces within the printed object (e.g., between adjacent horizontal layers), and the 3D printed object often will fail when subjected to a load. This occurs because the bonds between the layers are not robust. The limitations in material properties potentially results in both adhesive and cohesive fracture and ultimate failure of the 3D printed object or a structure constructed with 3D objects printed using binder jetting or extrusion.

Hence, there remains a need for new 3D printers, printing methods, or materials that are useful in forming 3D objects (“printed 3D objects”) that are useful in construction, building, and/or structural applications, and it is preferable that in many cases these 3D objects are larger in size than formed in many conventional 3D printers.

### SUMMARY

Briefly, the inventor recognized that construction-strength and/or construction-quality 3D objects can be printed with existing 3D printer technologies, such as binder jetting, extrusion, or the like, by providing a 3D printer material that includes one or more additives or additive materials in addition to the base material. The additives may be fine powders (or spherical additives), fibers, aggregates, or a combination thereof with the particular additive material(s) and the ratio of additive to base being carefully chosen to achieve desired physical and/or chemical characteristics in the 3D object printed using the new 3D printer material.

Previous binder jetting an extrusion processes did not include the additives, which may be spherical, may be fibers, and may be pozzolans, and, therefore, the conventional 3D printer material with just a base resulted in 3D printed materials with weaker mechanical properties. The addition of powders and/or fibers serves to strengthen the 3D printed material produced through binder jetting or extrusion. In particular, the new 3D printer materials address the issue of weak interfaces between printed horizontal layers since the additives either improve packing or bridge the layers of the 3D printed object.

More particularly, a printer material (or composite printer supply material) is provided for use as a print supply material for a three dimensional (3D) printer for printing 3D objects that are suited for use in construction applications. The printer material includes a volume of a base material and a volume of an additive material mixed with the base material. The additive material fills gaps in the base material to increase the density of the printer material and/or enhances binding between layers of an object printed with the 3D printer. In some embodiments, the 3D printer is configured for binder jetting, and the base material comprises a sand, a ceramic, a cement, a metal, or a plastic. In other embodiments, the 3D printer is configured for extrusion, and the base material comprises wet cement or a mixture of sand and epoxy.

In some cases, the additive material comprises a plurality of fibers or fiber-like particles with a high aspect ratio. In such implementations, the additive material may include at least one of wollastonite, carbon fibers, glass fibers, cellulose fibers, nylon fibers, thermoplastic fibers, polypropylene (PR) fibers, polyethylene terephthalate (PET) fibers, poly(vinyl alcohol) (PVA) fibers, helix steel, helical polymer, and dendritic fibers. When the additive is wholly or mostly (e.g., greater than 50 percent by volume fiber), the volume of the additive material may be in the range of 0 to 10 percent of the volume of the printer material.

In other cases, the additive material may include a plurality of spherical particles with a low aspect ratio. In these implementations, the additive material may include at least one of silica fume, metakaolin powder, rice husk ash powder, fly ash powder, stone aggregate, sand granular material, gravel, and slag stony waste matter. The spherical particles may include one or more pozzolans, and the additive material may further include a volume of lime. When the additive material is wholly or mostly (again over 50 percent by volume) spherical, the volume of the additive material may be in the range of 20 to 60 percent of the volume of the printer material. In some embodiments, the additive material may be formed as a mixture of fiberous material and spherical powder/material.

### BRIEF DESCRIPTION OF THE DRAWINGS

FIG. 1 is a functional block diagram of a 3D printer system during printing operations to print a 3D object for use in construction or structural applications using binder jetting;

FIG. 2 shows schematically the production or make up of a 3D printer material according to the present description that is useful with nearly any 3D printer or printer system including the printer system of FIG. 1;

FIG. 3 is a schematic illustration similar to FIG. 2 showing production of a 3D printer material for use with a binder jetting printer/printer system; and

FIG. 4 is a schematic illustration similar to FIG. 2 showing production of a 3D printer material for use with an extrusion printer/printer system.

### DETAILED DESCRIPTION

The inventor recognized that there is a demand for techniques for 3D printing of objects that have the strength, fracture, load bearing capacities, and/or other characteristics that make the objects useful in construction and structural applications. The inventor further understood that the limitations with conventionally 3D printed objects is the weak interfaces within the 3D printed object and the fact that the bonds between the printed horizontal layers are not robust.

The proposed solution to these issues to utilize conventional printers or printer systems such as those adapted for binder jetting or extrusion but to utilize a new 3D printer material. This 3D printer material may be considered a composite material adapted specifically for construction or structural applications because the 3D printer material is formed by the addition of additives to the base materials or constituents used in conventional printer materials. These additives may be provided as fine powders, fibers, or aggregates, and the additives may be added to the power bed (or powder supply) for binder jetting or to the liquid mix (or printer material supply) for extrusion.

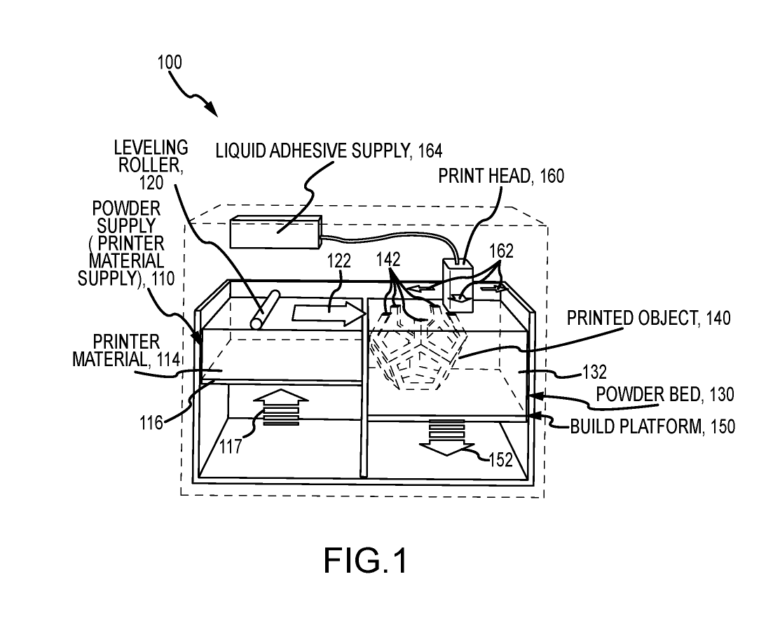

FIG. 1 illustrates 3D printer 100 that is configured for binder jetting (or 3D printing using binder jetting) a 3D object 140 (or “printed object”) using a new printer material 114 of the present description. The 3D printer 100 includes a power supply (or printer material supply) 110 in which a volume of the printer material (or composite material) 114 is provided for use in forming the printed object 140. The power powder supply 110 has a base 116 that can be raised 117 to supply an additional volume of the printer material 114 for each horizontal layer 142 of the printed object 140. To this end, a leveling roller 120 is selectively rolled 122 over the top of the printer material supply 110 to push new material 114 into a powder bed 130, and a build platform 150 is lowered 152 as each layer 142 of the object 140 is printed/formed. To form each layer 142, a print head 160 is selectively moved and positioned over the printer material 132 in the powder bed 130, and the head 160 is operated to dispense a binder provided by the supply 164 to cure or react with the printer material 132 (e.g., a liquid adhesive supply 164 may be utilized to glue the particles of the printer material 132 together).

During operations of the 3D printer 100, the part/object 140 is built up from many thin cross sections/layers 142 of a 3D model. The print head 160 (e.g., an inkjet print head or the like) moves 162 across a bed 130 of powder 132 selectively depositing a liquid binding material or binder from supply 164. A thin layer of printer material 114 from supply 110 is then spread across the completed section 142 by the leveling mechanism 120, and the process is repeated with each layer 142 adhering to the previously cured or reacted layer. When the object 140 is complete, unbound powder 132 is removed in a process called depowdering.

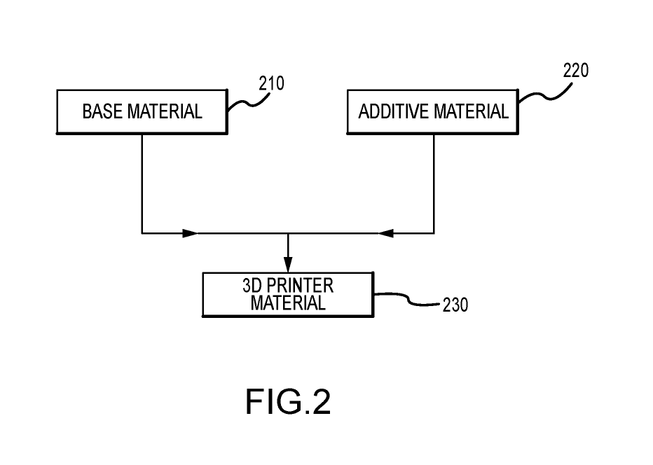

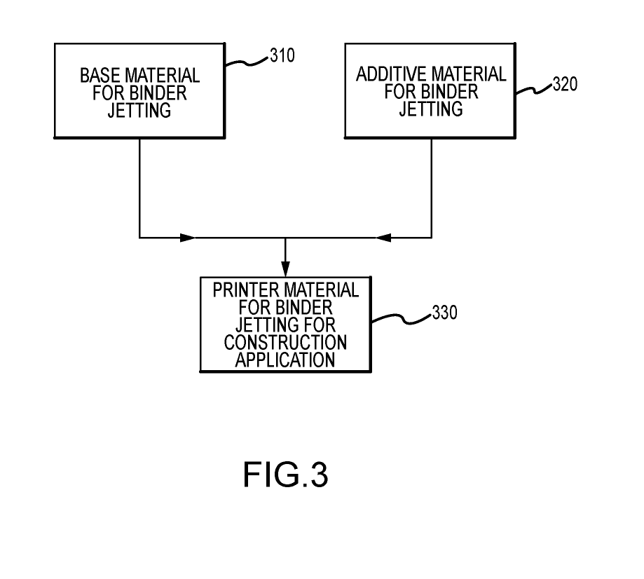

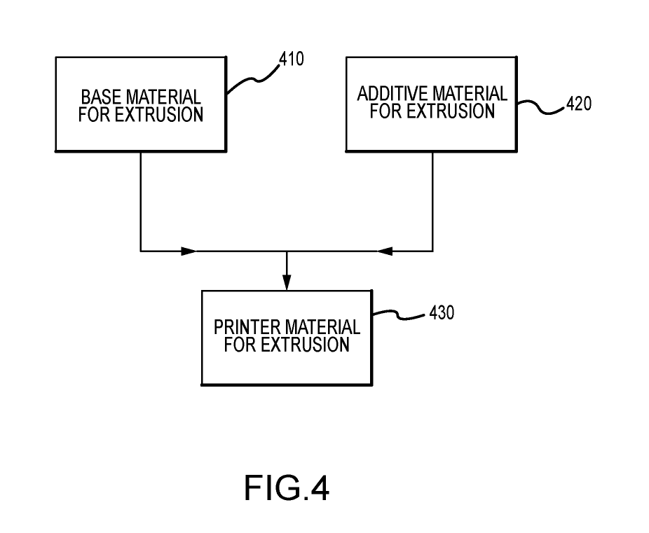

FIG. 2 illustrates schematically the production or formation of a 3D printer material 230 that may be used in a variety of 3D printers or printer systems (such as system 100 of FIG. 1 or in an extrusion-type printer). The 3D printer material 230 is formed by mixing a volume or quantity of base material (or a base) 210 with an additive material (or an additive) 220. As explained with reference to FIGS. 3 and 4 the particular materials used for the base 210 and the additive 220 may vary with the type of 3D printer or 3D printing technology used such as binder jetting, extrusion, or another technology.

Generally, however, the additive material may be a powder that is finer (e.g., made up of spherical components that are smaller in diameter or other dimensions) such that the additive material improves packing, by filling gaps, holes, and spaces, within the material of the printed 3D object. The fineness of the additive powder also increases the contact area available for bonding between horizontal layers. The increased packing and increased contact area cause a decrease in permeability to water and corrosive ions as well as providing a desired increase in compressive and flexural strength. In addition, the additive powders may be chosen to be pozzolans, which means that they chemically react with calcium hydroxide (slaked lime) to form compounds possessing cementitious properties. Therefore, adding lime to the printer material may be useful in some cases to increase the strength of the material in the 3D printed object even further.

In the case of fiber or fiber-like additives, the fibers increase the strength of the printed materials and can form a spatial grid to prevent contraction and reduce shrinkage cracks. This also reduces permeability to protect against water penetration and corrosion in a printed object, which makes the object more suitable for construction applications. For binder jetting in particular, the fibers of the additive serve to bridge the horizontal layers of the 3D printed material, and this provides a more stable connection between the layers and decreases the likelihood of failure along the interfaces. Hence, the use of spherical and/or fiber additives enhances material properties in the printed object without requiring disruptive changes to the printing process (or 3D printers).

FIGS. 3 and 4 show forming 3D printer material 330 and 430 for binder jetting and for extrusion, respectively, by combining base material 310 and additive material 320 suited for binder jetting and by combining base material 410 and additive material 420 suited for extrusion. There may be overlap in these materials and particularly in the additive materials 320, 420. With regard to the bases, the base material 310 for forming a printer material 330 for binder jetting may be sand, a ceramic, a cement, a metal, a plastic, or other material that often will be provided in powder form (e.g., a dry powder in a powder supply for moving into the powder bed of a binder jetting 3D printer system as shown at 100 in FIG. 1). A binder is then used in the 3D printer to cure (e.g., when the base is a ceramic or the like) or react with (e.g., when the base is cement or the like) the base material. The base material 410 for forming a printer material 430 for extrusion may be nearly any material that can be provided as an extrudable paste that will harden/cure after deposition from a print head in a horizontal layer of a 3D model such as wet cement, sand and epoxy, or the like.

With regard to the additives in the 3D printer material, a single additive may be added to any of the bases discussed herein or two or more of the additives may be added to achieve a desired physical or chemical characteristic in the 3D printer material. In other words, the terms “additive” and “additive material” are intended to mean one or more of the additives described herein. The additives may be divided into types or groups of additives including spherical additives and fiber additives. Spherical additives have a low aspect ratio with the length being equal or substantially equal to the height of each particle or piece. In contrast, fiber additives typically have particles or pieces that are fibers or fiber-like with a high aspect ratio with a length much greater than a width/diameter.

Spherical additives are useful for filling the spaces/gaps in the base material, e.g., fill holes in cement to make it much stronger. Fiber additives have a geometry that may be useful to obtain enhance binding and other functions in the 3D printer material. For example, the fibers (e.g., truncated steel helixes or the like) in the additive may stick out from a lower horizontal layer to provide better binding with subsequently printed horizontal layers of the 3D printer material in a 3D object. The fibers may have non-planar geometries to facilitate enhanced binding (e.g., the fibers cannot be laid flat).

The spherical additives used for (or as part of) the additives 220, 320, and 420 may vary widely to practice the invention with the following being exemplary and not limiting in nature. One spherical additive is silica fume (microsilica), which is an amorphous form of silicon dioxide (silica) that typically has a sub-micron particle diameter. Metakaolin powder is another exemplary spherical additive that is used to manufacture porcelain and has a particle diameter of a few microns. Rice husk ash powder may be used that can contain amorphous silica and may have a particle diameter in the range of 5 to 95 microns. Fly ash powder is another useful spherical additive that may contain both amorphous and crystalline silica, aluminum oxide, and calcium oxide and have a particle diameter in the range of 0.5 to 300 microns.

In other embodiments of the 3D printer material, such fine print resolution may not be required and spherical additives with larger diameters (e.g., about 1 millimeter (mm) to several millimeters (e.g., 5 mm or the like)) may be utilized. In such embodiments, stone aggregate may be used of one or more minerals or mineraloids. Sand granular material may also be used as the spherical additive and is generally material composed of finely divided rock and mineral particles. Gravel may also be used as the additive and is unconsolidated rock fragments. Slag stony waste matter may also be used as or in the additive, and it may be provided by separating it from metals during smelting or refining of ore.

The fiber additives used for (or as part of) the additives 220, 320, and 420 may also vary widely to practice the invention. For example, wollastonite may be used as an additive, and it is calcium silicate with a needle-like morphology and a diameter of 3 to 150 microns. Carbon fiber may also be used and has a high strength-to-weight ratio and a diameter of 5 to 10 microns. Glass fiber may be used instead even though it is weaker and less rigid than carbon fiber as it is also less expensive and less brittle which may be useful in some 3D printer materials. In some cases, it may be useful to include cellulose fiber as an additive as it is a reinforcing material derived from plants that has a low density and a low cost. Fibers from the nylon fiber family of polymers may be used due to their variety of commercial applications including reinforcement. Another exemplary fiber additive would be a thermoplastic fiber such as polypropylene (PR) fiber that is a thermoplastic polymer that is chemically inert. Polyethylene terephthalate (PET) fibers may be used, which are a readily available thermoplastic polymer that is recycled more commonly than other thermoplastics. Poly(vinyl alcohol) or PVA fibers may be used as the additive as PVA is a fiber polymer with high strength that is resistant to chemicals, fatigue, and abrasion. Helix steel may be used as or in the additive as it is commercially available as micro rebar and has a twisted conformation that prevents the steel fibers from lying flat in a plane, which may be useful to enhance binding between layers of a 3D printed object. Similarly, helical polymer could be used as the additive in a 3D printer material as it would have similar structure as helix steel but be formed of a polymer instead. In other cases, it may be useful to choose dendritic fibers for the additive as these fibers have fibers that branch out in three dimensions and, therefore, cannot lie flat in a plane (or are nonplanar) so may improve binding in a printed object.

The ratio of additive material to base material may be varied to practice the invention. For example, the ratio (or proportion) of additives in the 3D printer material can be adjusted or chosen based on cost and/or based on desired characteristics of the material of the printed 3D object (such as density requirements, strength ranges, fracture resistance, and the like). However, in general, a lot more base (by volume) may be used when the additive is wholly or mostly fibers whereas spherical additives may involve use of much larger ratios of additive. Note, though, the additive may be a mixture of fibers and spherical particles, with the addition of fibers often being useful to enhance binding between horizontal layers as portions of the fibers stick outward from the exposed surface of a previously printed (cured/reacted/hardened) layer.

In some specific implementations, it is expected that the 3D printer material will contain 0 to 10 percent additive (by volume) when the additive is wholly or mostly fibers (or a ratio in the range of 1:99 to 1:9). In some cases, the fiber additive will be provided in the range of 4 to 6 percent by volume in the 3D printer material. When the additive is spherical (or mostly spherical with some fiber additive), it is expected that the 3D printer material will contain 20 to 60 percent (or more) by volume spherical additive (or a ratio in the range of 1:4 to 3:2 (additive-to-base)).

Optimization of the ratios may be performed to suit the particular 3D printer system. For example, the 3D printer may be adapted to use binder jetting where it is desirable to print relatively smooth or “nice” layers. In contrast, the 3D printer may be adapted for extrusion in which it may be useful to optimize the additive to base ratio (which may be modified to suit the type of additive material) to achieve smooth flow (e.g., the rheology of the 3D printer material may be a key consideration and the type and quantity of additive may be selected based on its flow properties).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The use of the new 3D printer materials described herein should strengthen a 3D printed cementitious material. Therefore, the 3D printer materials represent an opportunity for competitive advantage to the user in construction in many environments. If the 3D printer materials are used in 3D printing of objects for use in construction, it could result in significant time and cost savings.

I claim:

1. A printer material for use as a print supply material for a three dimensional (3D) printer for printing 3D objects, comprising:
a volume of a base material; and
a volume of an additive material mixed with the base material, wherein the additive material fills gaps in the base material to increase the density of the printer material or enhances binding between layers of an object printed with the 3D printer.

2. The printer material of claim 1, wherein the 3D printer is configured for binder jetting and the base material comprises a sand, a ceramic, a cement, a metal, or a plastic.

3. The printer material of claim 1, wherein the 3D printer is configured for extrusion and the base material comprises wet cement or a mixture of sand and epoxy.

4. The printer material of claim 1, wherein the additive material comprises a plurality of fibers or fiber-like particles with a high aspect ratio.

5. The printer material of claim 4, wherein the additive material comprises at least one of wollastonite, carbon fibers, glass fibers, cellulose fibers, nylon fibers, thermoplastic fibers, polypropylene (PR) fibers, polyethylene terephthalate (PET) fibers, poly(vinyl alcohol) (PVA) fibers, helix steel, helical polymer, and dendritic fibers.

6. The printer material of claim 4, wherein the volume of the additive material is in the range of 0 to 10 percent of the volume of the printer material.

7. The printer material of claim 1, wherein the additive material comprises a plurality of spherical particles with a low aspect ratio.

8. The printer material of claim 7, wherein the additive material comprises at least one of silica fume, metakaolin powder, rice husk ash powder, fly ash powder, stone aggregate, sand granular material, gravel, and slag stony waste matter.

9. The printer material of claim 7, wherein the spherical particles include one or more pozzolans and wherein the additive material further comprises a volume of lime.

10. The printer material of claim 7, wherein the volume of the additive material is in the range of 20 to 60 percent of the volume of the printer material.

11. A printer material for use as a print supply material for a three dimensional (3D) printer for printing 3D objects, comprising:
a base material; and
an additive comprising a plurality of fibers or fiber-like particles with a high aspect ratio.

12. The printer material of claim 11, wherein the additive material comprises at least one of wollastonite, carbon fibers, glass fibers, cellulose fibers, nylon fibers, thermoplastic fibers, polypropylene (PR) fibers, polyethylene terephthalate (PET) fibers, poly(vinyl alcohol) (PVA) fibers, helix steel, helical polymer, and dendritic fibers.

13. The printer material of claim 11, wherein the volume of the additive material is in the range of 0 to 10 percent of the volume of the printer material.

14. The printer material of claim 11, wherein the 3D printer is configured for binder jetting and the base material comprises a sand, a ceramic, a cement, a metal, or a plastic.

15. The printer material of claim 11, wherein the 3D printer is configured for extrusion and the base material comprises wet cement or a mixture of sand and epoxy.

16. The printer material of claim 11, wherein the additive material further comprises at least one of silica fume, metakaolin powder, rice husk ash powder, fly ash powder, stone aggregate, sand granular material, gravel, slag stony waste matter, and one or more pozzolans and lime.

17. A printer material for use as a print supply material for a three dimensional (3D) printer for printing 3D objects, comprising:
a base material; and
an additive comprising a plurality of spherical particles with a low aspect ratio,
wherein the 3D printer is configured for binder jetting and the base material comprises a powder formed of a sand, a ceramic, a cement, a metal, or a plastic or for extrusion and the base material comprises a paste of wet cement or a mixture of sand and epoxy.

18. The printer material of claim 17, wherein the additive material comprises at least one of silica fume, metakaolin powder, rice husk ash powder, fly ash powder, stone aggregate, sand granular material, gravel, and slag stony waste matter.

19. The printer material of claim 17, wherein the spherical particles include one or more pozzolans and wherein the additive material further comprises a volume of lime.

20. The printer material of claim 17, wherein the additive material further comprises at least one of wollastonite, carbon fibers, glass fibers, cellulose fibers, nylon fibers, thermoplastic fibers, polypropylene (PR) fibers, polyethylene terephthalate (PET) fibers, poly(vinyl alcohol) (PVA) fibers, helix steel, helical polymer, and dendritic fibers.
